(19) United States
(12) Patent Application Publication
(10) Pub. No.: US 2003/0236853 A1
(43) Pub. Date: Dec. 25, 2003

(54) Method of data reading and writing

(76) Inventors: Yung-Fu Li, Jungli City (TW); Wei-Yu Chien, Taipei (TW); An-Bang Hsieh, Jungli City (TW); Jun-Ping Lin, Taipei (TW)

Correspondence Address: RABIN & CHAMPAGNE, PC, 1101 14TH STREET, NW, SUITE 500, WASHINGTON, DC, 20005, US

(21) Appl. No.: 10/292,752

(22) Filed: Nov. 13, 2002

(30) Foreign Application Priority Data
Jun. 19, 2002 (TW) 091113377

(51) Int. Cl. G06F 15/167

(52) U.S. Cl. 709/216

(57) ABSTRACT

A method of data reading and writing includes the following steps: when a service routine is called by a local device to execute an action of reading in a floppy disk drive or a CD-ROMdrive, the service routine will cancel the original action of accessing the local device, redirect the accessing command and related data, send a network packet including the redirected accessing command and inputted data to the remote device afterwards. Then, the agent program in the remote device will access the remote storage medium according to the received accessing command and related data, and transfer the requested data back to the local device to proceed with a booting procedure or to execute related programs under DOS.

This application incorporates by reference Taiwan application Serial No. 091113377, filed on Jun. 19, 2002.

### BACKGROUND OF THE INVENTION

1. Field of the Invention

The invention relates in general to a method of data reading and writing, and more particularly to a method of accessing a storage medium of a remote device by a local device.

2. Description of the Related Art

Nowadays, the technology of network computing has been developed to the stage, where a local device can be used to access a remote device, either to read or to write, via the network. However, this method of data access is based on a network supportive operation system (OS), such as Windows operation system. That is, if both a local device and a remote device use a network supportive OS, then the local device can access data in the storage medium of the remote device. The above mentioned local device and the remote device can be a server or a personal computer, and the remote storage medium included in the remote device can be a hard disk drive, floppy disk drive, CD-ROM drive, DVD-ROM drive, Zip drive, or LS-120 drive, and so on.

If the local device adopts an OS which is not a network supportive OS, such as DOS, or the local device has not downloaded a network supportive OS yet, then the data in the remote storage medium cannot be accessed via the network. This is a problem that needs to be solved at this stage of technological development.

### SUMMARY OF THE INVENTION

It is therefore an object of the invention to provide a method of data reading and writing to access remote data not in an environment of a network supportive OS.

The invention achieves the above-identified objects by providing a method of data reading and writing, which comprises the following steps.

When the Basic Input Output System (BIOS) of a local device downloads an operation system or DOS to access a disk or CD, a service routine in the BIOS is called to execute an action of reading from a floppy disk drive or a CD-ROM drive. The service routine responding to the call from the local device will cancel the original action of accessing the local device, redirect the accessing command and related data, and then pass them to a management program of the local device. Then, the management program send a network packet includes the received accessing command and related data to a remote device via the network. The agent program in the remote device will access the remote storage medium according to the received accessing command and related data, and transfer the requested data back to the management program. Finally, the management program reformats the received data packets into the format suited to the BIOS, and transfers them on to the BIOS. Then, the booting procedure can proceed, or the corresponding programs can be carried out in a DOS system.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 illustrates a method of accessing data from a remote storage medium via the network according to a preferred embodiment of the invention;

FIG. 2 illustrates a system diagram of the local device and the remote device in FIG. 1;

FIG. 3 illustrates a flow chart of a method of writing to a remote storage medium by a local device according to a preferred embodiment of the invention; and

FIG. 4 illustrates a flow chart of a method of reading from a remote storage medium by a local device according to a preferred embodiment of the invention.

### DESCRIPTION OF THE PREFERRED EMBODIMENT

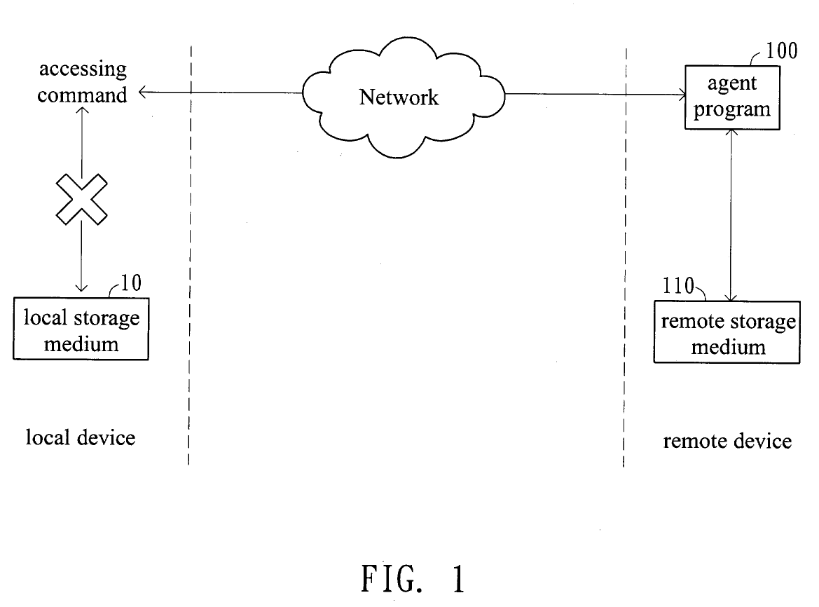

Referring to FIG. 1, it illustrates a method of accessing data from a remote storage medium via the network according to a preferred embodiment of the invention. The idea of this invention is that when a local device needs to access a local storage medium 10, such as a local floppy disk, a local CD-ROM, and so on, the accessing command and related data can be redirected, the action of accessing the local storage medium 10 can fail or be cancelled, and the accessing command can be passed to a remote device via the network to execute the action of data access a remote storage medium 110 by a remote agent program 100, wherein the agent program can be based on the operation system of a remote device. This operation system can be Windows or other network-supportive operation systems. That is, through the function of redirecting the commands, the local device can cancel the original accessing of the local storage medium, and then access the remote storage medium 110 via the network. By this method, a remote storage medium can be easily used to replace a local storage medium, and the object of remote management can then be achieved.

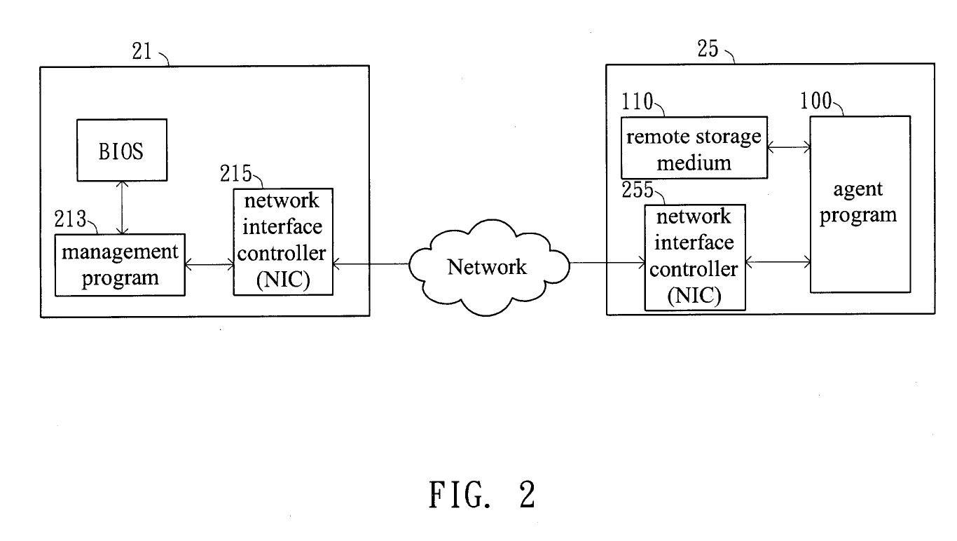

The above idea of this invention can be attained by providing a systematic frame of accessing a remote storage medium via the network, such as shown in FIG. 2. The management program 213 of a local device 21 can pack commands or data from the BIOS into network packets, and send them to the network via a network interface controller (NIC) 215. Then, those packets can be received by a network interface controller 255 of a remote device 25. Next, the packets received by the NIC 215 can be reformatted by a management program 213 to suit the BIOS, and be transferred back to the BIOS for further processing, wherein the management program 213 can be a firmware or software to carry it out.

When the BIOS of the local device 21 downloads an operation system, meaning the local device proceeds with a booting procedure, or DOS to access a disk or CD-Rom, a service routine in the BIOS is called to execute the action of accessing a floppy disk drive or a CD-ROM drive. The service routine can be INT 13h for example. In response to the call from the local device 21, the service routine will cancel the action of accessing the local storage medium and redirect the accessing command and related data to the management program 213. The management program 213 packs the received accessing command and related data into network packets, and transports them to the remote device 25 via the network. The agent program 100 in the remote device 25 can access the remote storage medium according to the received accessing command and related data, and transfer the obtained data to the management program 213. At last, the management program 213 reformats the received data to suit the BIOS, and transfers them to the BIOS to proceed with the starting procedure or to execute a related program in DOS.

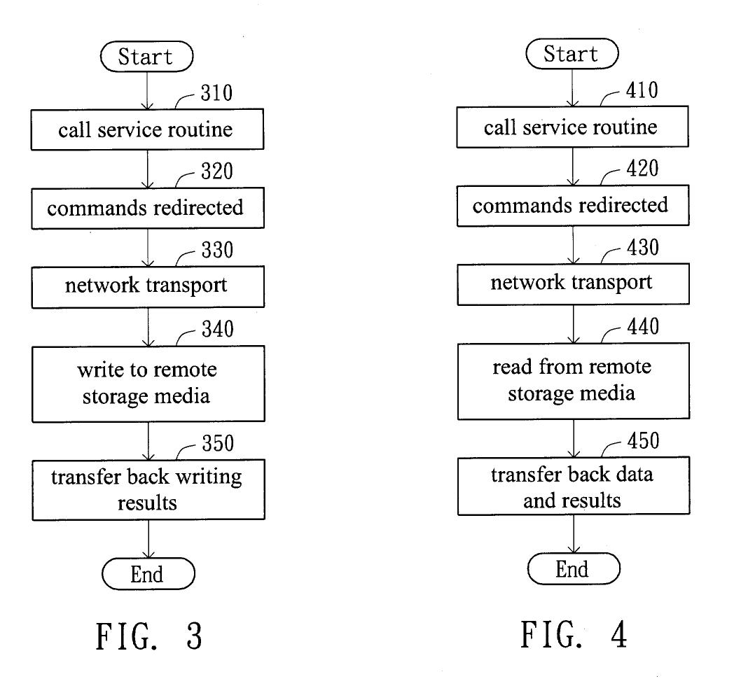

Referring to FIG. 3, it illustrates a flow chart of a method of writing to a remote storage medium by a local device. When the local device 21 is to write data to a storage medium, the related service routine will be called to execute the action of writing to the floppy disk drive or CD-ROM drive (Step 310) At this time, the service routine will cancel the original action of writing to a local storage medium, and redirect the accessing command and related inputted data to the remote device 25 (Step 320). Afterwards, the accessing command and inputted data can be packed into network packets and transported to the remote device via the network (Step 330). Next, the agent program 100 writes the input data to the remote storage medium 110 according to the accessing command (Step 340), and then transfers the writing result back to the BIOS (Step 350).

Referring to FIG. 4, it illustrates a flow chart of a method of reading from a remote storage medium by a local device. When the local device 21 is to read data from a storage medium, the related service routine will be called to execute the action of reading from a floppy disk drive or a CD-ROM drive (Step 410). At this time, the service routine will cancel the original action of reading from a local storage medium, and redirect the accessing command to the remote device 25 (Step 420). Afterwards, the accessing command can be packed into network packets and transported to the remote device via the network (Step 430); next, the agent program 100 will read the data from the remote storage medium 110 according to the accessing command (Step 440). Then, the read data is packed into network packets and transferred back to the local device (Step 450). The management program 213 reformats the received data to suit the BIOS, and transfers them to the BIOS to proceed with the starting procedure or to execute a related program in DOS.

The characteristics of this invention are to redirect the accessing command and related data through a BIOS service routine, to transfer the redirected accessing command and data to the remote device 25 via the network by the management program 213, to access the remote storage medium 110 according to the received command and data by the agent program 110 of the remote device 25, to transfer the result and data back to the management program 213, and then to transfer the information back to BIOS after processing. By this technique, a remote storage medium can be used as a local storage medium by a local device.

As disclosed above, the method of data access provides at least the following advantages:

1. Remote management: It can be achieved to update a firmware of a local device, such as BIOS, or execute a checking program from a remote end.

2. Hardware replacement: If there is no floppy disk drive, CD-ROM drive, or other storage medium included in a local device, or those storage media are broken, and there is such a medium in a remote device, then the remote storage medium can be applied to replace the local floppy disk drive or CD-ROM drive.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of data writing for a local device and a remote device which are connected by the network, wherein the remote device includes a remote storage medium, and the local device is used for writing an inputted data to the remote storage medium, the method of data writing comprising the following steps:
calling a service routine to execute an accessing command of writing the inputted data to a local storage medium at the local device;
redirecting the accessing command and outputting the redirected accessing command and the inputted data in response to the local device;
transferring the redirected accessing command and the inputted data to the remote device in a network packet form;
writing the inputted data to the remote storage medium according to the accessing command by the remote device; and
transferring a writing result back to the local device.

2. The method of data writing according to claim 1, wherein the local device is a server.

3. The method of data writing according to claim 1, wherein the local device is a personal computer (PC).

4. The method of data writing according to claim 1, wherein the remote device is a server.

5. The method of data writing according to claim 1, wherein the remote device is a personal computer (PC).

6. The method of data writing according to claim 1, wherein the remote storage medium is a floppy disk drive.

7. The method of data writing according to claim 1, wherein the remote storage medium is a CD-ROM drive.

8. The method of data writing according to claim 1, wherein the remote storage medium is a ZIP drive.

9. The method of data writing according to claim 1, wherein the remote storage medium is a LS-120 drive.

10. A method of data reading for a local device and a remote device which are connected by the network, wherein the remote device includes a remote storage medium, and the local device is used for reading a target data from the remote storage medium, the method of data reading comprising the following steps:
calling a service routine to execute an accessing command of reading a local storage medium at the local device;
redirecting the accessing command and outputting the redirected accessing command in response to the local device;
transferring the redirected accessing command to the remote device in a network packet form;
reading the target data from the remote storage medium according to the accessing command by the remote device; and
transferring a reading result back to the local device in a network packet form.

11. The method of data reading according to claim 10, wherein the local device is a server.

12. The method of data reading according to claim 10, wherein the local device is a personal computer (PC).

13. The method of data reading according to claim 10, wherein the remote device is a server.

14. The method of data reading according to claim 10, wherein the remote device is a personal computer (PC).

15. The method of data reading according to claim 10, wherein the remote storage medium is a floppy disk drive.

16. The method of data reading according to claim 10, wherein the remote storage medium is a CD-ROM drive.

17. The method of data reading according to claim 10, wherein the remote storage medium is a ZIP drive.

18. The method of data reading according to claim 10, wherein the remote storage medium is an LS-120 drive.
